(19) United States
(12) Patent Application Publication
(10) Pub. No.: US 2023/0016062 A1
(43) Pub. Date: Jan. 19, 2023

(54) RESIN COMPOSITION, MOLDED ARTICLE, AND METHOD FOR PRODUCING MOLDED ARTICLE

(71) Applicant: DAIKIN INDUSTRIES, LTD., Osaka (JP)

(72) Inventors: Hirofumi MUKAE, Osaka (JP); Hideki KONO, Osaka (JP); Masaji KOMORI, Osaka (JP); Ayane NAKAUE, Osaka (JP); Hiroshi ITO, Yamagata-shi (JP)

(73) Assignee: DAIKIN INDUSTRIES, LTD., Osaka (JP)

(21) Appl. No.: 17/941,822

(22) Filed: Sep. 9, 2022

Related U.S. Application Data
(63) Continuation of application No. PCT/JP2021/008754, filed on Mar. 5, 2021.

(30) Foreign Application Priority Data
Mar. 10, 2020 (JP) 2020-040962

(51) Int. Cl. C08L 27/18; C08L 67/00

(52) U.S. Cl. CPC C08L 27/18; C08L 67/00

(57) ABSTRACT

A resin composition containing: a melt-fabricable fluororesin containing at least one functional group selected from a carbonyl group-containing group and a hydroxy group; at least one fluorine-free resin selected from a liquid crystal polymer, a polyarylene sulfide, and an aromatic polyether ketone; and particulate boron nitride, wherein the particulate boron nitride is contained in an amount of 30 to 65% by volume.

### CROSS REFERENCE TO RELATED APPLICATIONS

This application is Rule 53(b) continuation of International Application No. PCT/JP2021/008754 filed Mar. 5, 2021, which claims priority from Japanese Patent Application No. 2020-040962 filed Mar. 10, 2020, the above-noted applications incorporated herein by reference in their entireties.

### TECHNICAL FIELD

The disclosure relates to resin compositions, molded articles, and methods for producing molded articles.

### BACKGROUND ART

Patent Literature 1 discloses a resin composition containing a melt-moldable fluororesin and a liquid crystal polymer, wherein the melt-moldable fluororesin has a melting point of 100° C. or higher and 325° C. or lower and contains at least one functional group selected from the group consisting of a carbonyl group-containing group, a hydroxy group, an epoxy group, and an isocyanate group.

Patent Literature 2 discloses a polymeric article containing a melt-fabricable blend of a melt-viscid fluoropolymer and a liquid crystal polymer (LCP). Patent Literature 2 states that the polymeric article may further contain a filler.

Patent Literature 3 discloses a polyphenylene sulfide resin composition containing 99 to 51% by volume of a polyphenylene sulfide resin (a) and 1 to 49% by volume of a reactive functional group-containing fluororesin (b) relative to 100% by volume of the total of the component (a) and the component (b), the component (a) forming a continuous phase (sea phase) and the component (b) forming a dispersed phase (island phase) in morphological observation with an electron microscope, the number average dispersed particle size r1 of the dispersed phase consisting of the component (b) and the number average dispersed particle size r2 of the dispersed phase consisting of the component (b) after melt accumulation at 320° C. for 30 minutes giving a ratio r2/r1 of 1.5 or lower. Patent Literature 3 states that the resin composition may contain an inorganic filler.

Patent Literature 4 discloses a polyphenylene sulfide resin composition containing a polyphenylene sulfide resin (a), a fluororesin (b), and an organic silane compound (c). When a resin phase-separated structure of a molded article formed from the polyphenylene sulfide resin composition is observed by an electron microscope, the component (a) forms a continuous phase, the component (b) forms a primary dispersed phase having a number average dispersed diameter of not greater than 1 μm, and a secondary dispersed phase of the component (a) is included in the primary dispersed phase of the component (b). Patent Literature 4 states that the resin composition may contain an inorganic filler.

### CITATION LIST

### Patent Literature

Patent Literature 1: JP 2018-177931 A

Patent Literature 2: JP 2014-528492 T

Patent Literature 3: JP 2015-110732 A

Patent Literature 4: WO 2017/131028

### SUMMARY

The disclosure relates to a resin composition containing: a melt-fabricable fluororesin containing at least one functional group selected from the group consisting of a carbonyl group-containing group and a hydroxy group; at least one fluorine-free resin selected from the group consisting of a liquid crystal polymer, a polyarylene sulfide, and an aromatic polyether ketone; and particulate boron nitride.

### Advantageous Effects

The resin composition of the disclosure has high heat dissipation and low relative permittivity while also having excellent moldability.

### DESCRIPTION OF EMBODIMENTS

The present inventors found out that the combined use of a fluororesin and a specific fluorine-free resin can provide a composition having excellent moldability even when a large amount of particulate boron nitride is added for heat dissipation. The inventors thus completed the resin composition of the disclosure.

The disclosure is specifically described hereinbelow.

The disclosure relates to a resin composition containing: a melt-fabricable fluororesin containing at least one functional group selected from the group consisting of a carbonyl group-containing group and a hydroxy group; at least one fluorine-free resin selected from the group consisting of a liquid crystal polymer, a polyarylene sulfide, and an aromatic polyether ketone; and particulate boron nitride.

A conventional fluororesin mixed with a heat dissipation filler such as boron nitride for increased heat dissipation has significantly high melt viscosity. Such a resin causes difficulty in molding, especially in injection molding, which limits processing methods and in turn significantly limits applications of the resin.

The resin composition of the disclosure has the above features and thus has excellent heat dissipation and low relative permittivity while also having excellent moldability. Thus, the resin composition can particularly be subjected to injection molding and can be used for versatile applications. The resin composition of the disclosure also has excellent heat resistance.

The fluororesin is a melt-fabricable fluororesin. The term “melt-fabricable” herein means that a polymer can be melted and processed using a conventional processing device such as an extruder or an injection molding machine.

The fluororesin contains at least one functional group selected from the group consisting of a carbonyl group-containing group and a hydroxy group.

Examples of the carbonyl group-containing group include: a group having a carbonyl group between carbon atoms of a hydrocarbon group; a carbonate group; a carboxy group; a haloformyl group; an alkoxycarbonyl group; and an acid anhydride group. For the group having a carbonyl group between carbon atoms of a hydrocarbon group, an example of the hydrocarbon group is a C2-C8 alkylene group. The alkylene group may be linear or branched. Here, the number of carbon atoms of the alkylene group is the number of carbon atoms excluding the carbon atoms constituting the carbonyl group. The haloformyl group is a group represented by —C(═O)—X (wherein X is a halogen atom). Examples of the halogen atom include a fluorine atom and a chlorine atom. Preferred among these is a fluorine atom. The haloformyl group is preferably a fluoroformyl group (also referred to as a carbonyl fluoride group). The alkoxy group of the alkoxycarbonyl group may be linear or branched. In particular, a C1-C8 alkoxy group is preferred. A methoxy group or an ethoxy group is particularly preferred.

The number of functional groups in the fluororesin is preferably 1 to 60000, more preferably 10 to 50000, still more preferably 30 to 10000, particularly preferably 50 to 5000 per 1×10⁶ main chain carbon atoms of the fluororesin. When the number of functional groups is not smaller than the lower limit of the above range, the fluororesin has significantly high compatibility with the liquid crystal polymer. When the number of functional groups is not greater than the upper limit of the above range, the fluororesin has excellent compatibility during melt kneading. The number of functional groups is determined by compression-molding a cut piece of a pellet at room temperature to form a film having a thickness of 50 to 200 μm and analyzing this film by infrared absorption spectrometry.

The fluororesin preferably has a melting point of 100° C. or higher and 325° C. or lower, more preferably 160° C. or higher and 320° C. or lower, still more preferably 180° C. or higher and 320° C. or lower. The melting point herein is the temperature corresponding to the maximum value on a heat-of-fusion curve drawn by increasing the temperature at a rate of 10° C./min using a differential scanning calorimeter (DSC).

The fluororesin preferably has a melt flow rate (MFR) of 10 g/10 min or higher, more preferably 20 g/10 min or higher, while preferably 200 g/10 min or lower, more preferably 100 g/10 min or lower.

The MFR of the fluororesin is a value obtained as the mass (g/10 min) of a polymer that flows out of a nozzle having an inner diameter of 2.095 mm and a length of 8 mm per 10 minutes at a predetermined measurement temperature (e.g., 372° C. for PFA and FEP to be described later, 297° C. for ETFE) and load (e.g., 5 kg for PFA, FEP, and ETFE) in accordance with the type of the fluoropolymer using a melt indexer in conformity with ASTM D1238.

Examples of the fluororesin include a tetrafluoroethylene (TFE)/perfluoro(alkyl vinyl ether) (PAVE) copolymer (PFA), a TFE/hexafluoropropylene (HFP) copolymer (FEP), an ethylene (Et)/TFE copolymer (ETFE), an Et/TFE/HFP copolymer (EFEP), polychlorotrifluoroethylene (PCTFE), a chlorotrifluoroethylene (CTFE)/TFE copolymer, an Et/CTFE copolymer, polyvinyl fluoride (PVF), and polyvinylidene fluoride (PVDF).

The PAVE is preferably a monomer represented by the following formula:

CF₂═CF—ORf¹ (1)

(wherein Rf¹ represents a C1-C8 perfluoroalkyl group). Specific examples of the PAVE include perfluoro(methyl vinyl ether) (PMVE), perfluoro(ethyl vinyl ether) (PEVE), perfluoro(propyl vinyl ether) (PPVE), and perfluoro(butyl vinyl ether).

In particular, the fluororesin preferably includes at least one selected from the group consisting of PFA, FEP, and ETFE, more preferably at least one selected from the group consisting of PFA and FEP, and is still more preferably PFA. The fluororesin is also preferably a perfluororesin.

The PFA and FEP are not limited. The mole ratio of a TFE component is preferably 70 to 99, more preferably 80 to 98.9. Too small an amount of the TFE unit tends to cause reduced mechanical properties. Too large an amount thereof tends to cause too high a melting point and reduced moldability.

The PFA is preferably a copolymer having a mole ratio of a TFE unit to a PAVE unit (TFE unit/PAVE unit) of 70/30 or higher and lower than 99/1, more preferably 70/30 or higher and 98.9/1.1 or lower. Too small an amount of the TFE unit tends to cause reduced mechanical properties. Too large an amount thereof tends to cause too high a melting point and reduced moldability. A monomer other than TFE and PAVE may be copolymerized as long as it does not impair the effects of the invention.

The PFA preferably has a melting point of 180° C. or higher and lower than 324° C., more preferably 230° C. to 320° C., still more preferably 280° C. to 320° C.

The FEP is preferably a copolymer having a mole ratio of a TFE unit to a HFP unit (TFE unit/HFP unit) of 70/30 or higher and lower than 99/1, more preferably 70/30 or higher and 98.9/1.1 or lower. Too small an amount of the TFE unit tends to cause reduced mechanical properties. Too large an amount thereof tends to cause too high a melting point and reduced moldability. A monomer other than TFE and HFP may be copolymerized as long as it does not impair the effects of the invention.

The FEP preferably has a melting point of 150° C. or higher and lower than 324° C., more preferably 200° C. to 320° C., still more preferably 240° C. to 320° C.

The ETFE is preferably a copolymer having a mole ratio of a TFE unit to an ethylene unit (TFE unit/ethylene unit) of 20/80 or higher and 90/10 or lower. The mole ratio is more preferably 37/63 or higher and 85/15 or lower. A monomer other than TFE and ethylene may be copolymerized as long as it does not impair the effects of the invention.

The ETFE preferably has a melting point of 140° C. or higher and lower than 324° C., more preferably 160° C. to 320° C., still more preferably 195° C. to 320° C.

The amounts of the respective monomer units of the aforementioned copolymers each can be calculated by any appropriate combination of NMR, FT-IR, elemental analysis, and X-ray fluorescence analysis in accordance with the types of the monomers.

To decrease relative permittivity, the resin composition of the disclosure preferably contains the fluororesin in an amount of 10 to 50% by volume. The amount is more preferably 15% by volume or more, still more preferably 20% by volume or more, particularly preferably 24% by volume or more. To improve moldability, the amount is more preferably 45% by volume or less, still more preferably 40% by volume or less, particularly preferably 36% by volume or less.

The fluorine-free resin includes at least one selected from the group consisting of a liquid crystal polymer, a polyarylene sulfide, and an aromatic polyether ketone.

The liquid crystal polymer is not limited, but is preferably a thermotropic liquid crystal polymer that becomes a liquid crystal state such as a nematic state when heated. Examples thereof include:

type-I liquid crystal polymers (e.g., a biphenol/benzoic acid/para-hydroxybenzoic acid (POB) copolymer);
type-II liquid crystal polymers (e.g., a hydroxynaphthoic acid (HNA)/POB copolymer); and
type-III liquid crystal polymers (e.g., a POB/ethylene terephthalate copolymer). In particular, the liquid crystal polymer preferably includes at least one selected from the group consisting of type-II liquid crystal polymers such as hydroxynaphthoic acid (HNA)/POB copolymers and type-III liquid crystal polymers such as POB/ethylene terephthalate copolymers in terms of the kneading temperature and the liquid crystal transition temperature.

The liquid crystal transition starting temperature of the liquid crystal polymer is preferably, but is not limited to, a temperature not higher than the processing temperature of the fluororesin. For example, since the processing temperature of PFA is 320° C. or higher, the liquid crystal transition starting temperature is preferably 300° C. or lower, more preferably 200° C. to 300° C., still more preferably 220° C. to 290° C. The liquid crystal polymer with a liquid crystal transition starting temperature of lower than 200° C. tends to decompose at a kneading temperature to reduce the dispersion effect. The liquid crystal polymer with a liquid crystal transition starting temperature of higher than 300° C. tends to increase the melt viscosity at a kneading temperature, failing to achieve an effect of improving the fluidity. The liquid crystal starting temperature herein means a temperature at which a liquid crystal polymer mounted on the sample holder of a polarization microscope becomes opalescent when heated under shear stress.

An example of the polyarylene sulfide (PAS) is a resin containing a polymer that has a repeating unit represented by the following formula:

[symbol]

Ar—S [symbol] [Chem. 1]

(wherein Ar represents an arylene group). The proportion of the repeating unit contained in the resin is preferably 70 mol % or higher.

Examples of the arylene group for Ar include p-phenylene, m-phenylene, o-phenylene, alkyl-substituted phenylene, phenyl-substituted phenylene, halogen-substituted phenylene, amino-substituted phenylene, amide-substituted phenylene, p,p′-diphenylene sulfone, p,p′-biphenylene, and p,p′-biphenylene ether.

The PAS is not limited. An example thereof is polyphenylene sulfide (PPS).

The PAS preferably has a melt flow rate (MFR) of 30 to 400 g/10 min, more preferably 40 to 300 g/10 min, still more preferably 60 to 200 g/10 min as measured at 295° C. at a load of 5 kg. A MFR within the above range allows the resulting resin composition to have further excellent moldability. The MFR of the PAS is measured using a melt indexer in conformity with ASTM D 1238.

The aromatic polyether ketone may be any one containing a repeating unit having an arylene group, an ether group (—O—), and a carbonyl group (—C(═O)—). For example, it contains a repeating unit represented by any of the following formulas (a1) to (a5):

[—Ar¹—O—Ar¹—C(═O)—] (a1);

[—Ar¹—O—Ar¹—C(═O)—Ar¹—C(═O)—] (a2);

[—Ar¹—O—Ar¹—O—Ar¹—C(═O)—] (a3);

[—Ar¹—O—Ar¹—C(═O)—Ar¹—O—Ar¹—C(═O)—Ar¹—C(═O)—] (a4);

and

[—Ar¹—O—Ar¹—O—Ar¹—C(═O)—Ar¹—C(═O)—] (a5),

wherein Ar¹is an optionally substituted divalent aromatic hydrocarbon ring group.

Examples of the divalent aromatic hydrocarbon ring group for Ar¹ include: C6-C10 arylene groups such as a phenylene group (e.g., an o-, m-, or p-phenylene group) and a naphthylene group; biarylene groups (each arylene group has a carbon number of 6 to 10) such as a biphenylene group (e.g., a 2,2′-biphenylene group, a 3,3′-biphenylene group, or a 4,4′-biphenylene group); and terarylene groups (each arylene group has a carbon number of 6 to 10) such as an o-, m-, or p-terphenylene group. These aromatic hydrocarbon ring groups may have any substituent such as a halogen atom, an alkyl group (e.g., a linear or branched C1-C4 alkyl group such as a methyl group), a haloalkyl group, a hydroxy group, an alkoxy group (e.g., a linear or branched C1-C4 alkoxy group such as a methoxy group), a mercapto group, an alkylthio group, a carboxyl group, a sulfo group, an amino group, a N-substituted amino group, or a cyano group. In the repeating units (a1) to (a5), Ar¹ groups may be the same as or different from each other. Ar¹ is preferably a phenylene group (e.g., a p-phenylene group) or a biphenylene group (e.g., a 4,4′-biphenylene group).

An example of a resin having the repeating unit (a1) is polyetherketone (e.g., “PEEK-HT” available from Victrex). An example of a resin having the repeating unit (a2) is polyetherketoneketone (e.g., “PEKK” available from Arkema+Oxford Performance Materials). Examples of a resin having the repeating unit (a3) include polyetheretherketone (e.g., “VICTREX PEEK” available from Victrex; “Vestakeep®” available from Evonik; “Vestakeep-J” available from Daicel-Evonik; “KetaSpire®” available from Solvay Specialty Polymers), and polyether-diphenyl-ether-phenyl-ketone-phenyl (e.g., “Kadel®” available from Solvay Specialty Polymers). An example of a resin having the repeating unit (a4) is polyetherketoneetherketoneketone (e.g., “VICTREX ST” available from Victrex). An example of a resin having the repeating unit (a5) is polyetheretherketoneketone. In the repeating unit having an arylene group, an ether group, and a carbonyl group, the ratio (E/K) of an ether segment (E) to a ketone segment (K) is, for example, 0.5 to 3, preferably about 1 to 2.5. The ether segment imparts flexibility to the molecule chain and the ketone segment imparts stiffness to the molecule chain. Thus, the larger the amount of the ether segment is, the higher the crystallization speed is and the higher the crystallinity to be finally achieved tends to be, while the larger the amount of the ketone segment is, the higher the glass transition temperature and the melting point tend to be. These aromatic polyether ketones may be used alone or in combination of two or more.

Preferred among these aromatic polyether ketones are aromatic polyether ketones having any of the repeating units (a1) to (a4). For example, the aromatic polyether ketone is preferably at least one resin selected from the group consisting of polyetherketone, polyetheretherketone, polyetherketoneketone, and polyetherketoneetherketoneketone, more preferably at least one resin selected from the group consisting of polyetherketone, polyetheretherketone, and polyetherketoneketone, still more preferably polyetheretherketone.

The aromatic polyether ketone preferably has a melt flow rate (MFR) of 10 to 300 g/10 min, more preferably 30 to 200 g/10 min, still more preferably 50 to 150 g/10 min as measured at 380° C. and a load of 5 kg. A MFR within the range allows the resulting resin composition to have further excellent moldability. The MFR of the aromatic polyether ketone is determined using a melt indexer in conformity with ASTM D1238.

To improve moldability and thermal conductivity, the resin composition of the disclosure preferably contains the fluorine-free resin in an amount of 10 to 50% by volume. The amount is more preferably 12% by volume or more, still more preferably 14% by volume or more, particularly preferably 16% by volume or more.

The amount is more preferably 40% by volume or less, still more preferably 38% by volume or less, further preferably 35% by volume or less, particularly preferably 30% by volume or less.

The particulate boron nitride contained in the resin composition of the disclosure is preferably particulate hexagonal boron nitride (hBN). When containing particulate boron nitride, the resin composition of the disclosure can have improved heat dissipation. The heat dissipation as used herein is evaluated based on the thermal conductivity of the resin composition.

The particulate boron nitride contained in the resin composition of the disclosure preferably has a 50% particle size (D50) of 30 μm or smaller, more preferably 20 μm or smaller. The 50% particle size is also preferably 3 μm or greater, more preferably 5 μm or greater. Controlling the 50% particle size of the particulate boron nitride contained in the resin composition of the disclosure within the above range allows the MFR of the resin composition to fall within the range described later, whereby the resin composition has excellent injection moldability. Further, relatively large particles occupy a small proportion in this case, which enables stress dispersion and allows the resin composition of the disclosure to have a high tensile strain at break and also to have improved toughness.

The 50% particle size can be determined from the particle size distribution determined using a laser diffraction particle size distribution analyzer.

The particulate boron nitride contained in the resin composition of the disclosure preferably has a 90% particle size (D90) of 150 μm or smaller, more preferably 130 μm or smaller, still more preferably 100 μm or smaller, while preferably 30 μm or greater, more preferably 40 μm or greater, still more preferably 50 μm or greater. This allows the resin composition of the disclosure to have both heat dissipation and moldability at a much higher level. The 90% particle size can be determined from the particle size distribution determined using a laser diffraction particle size distribution analyzer.

The particulate boron nitride contained in the resin composition of the disclosure preferably has a kurtosis of 0 or lower. This allows the resin composition to have both heat dissipation and moldability at a much higher level. The kurtosis is positive when the distribution is more peaked than the normal distribution, while it is negative when the distribution is flatter than the normal distribution. The normal distribution has a kurtosis of 0. The kurtosis is more preferably 0.1 or lower, still more preferably −0.3 or lower.

The kurtosis can be determined from the particle size distribution measured using a laser diffraction particle size distribution analyzer. Specifically, the kurtosis can be calculated from the following equation.

$$\{ \frac{n ( n + 1 )}{( n - 1 ) ( n - 2 ) ( n - 3 )} \sum {( \frac{{χ}_{i} - \overline{χ}}{s} )}^{4} \} - \frac{3 {( n - 1 )}^{2}}{( n - 2 ) ( n - 3 )} \qquad [ Math . 1 ]$$

$$( wherein n is the number of particle size data sets , s is the standard Deviation of the particle size , {χ}_{i} is the individual particle size data value , and \overline{χ} is the arithmetic mean of the particle size )$$

The particulate boron nitride contained in the resin composition of the disclosure is preferably substantially free from particles having a particle size of 500 μm or greater, more preferably substantially free from particles having a particle size of 300 μm or greater. This allows the resin composition to have both heat dissipation and moldability at a much higher level. That the particulate boron nitride is substantially free from particles having a particle size within the above range means that particles having a particle size within the above range in the particle size distribution determined using a laser diffraction particle size distribution analyzer occupy 0.1% or less.

The particle size distribution of the particulate boron nitride as used herein is measured using a laser diffraction particle size distribution analyzer (e.g., laser diffraction particle size distribution analyzer Mastersizer 3000+Hydro R, available from Malvern Panalytical Ltd.) under the following conditions.

### (Measurement Conditions)

Solvent: ethanol
Solvent amount: 45 ml
Stirring conditions: 3000 rpm
Laser scattering intensity: 10 to 20%

In the case where the particle size distributions of the particulate boron nitride in the resin composition of the disclosure are within the aforementioned respective ranges, the particulate boron nitride is allowed to be present densely in the resin composition and can therefore reduce an increase in the melt viscosity. The presence of a reasonably large particulate boron nitride leads to excellent heat conduction. This results in a resin composition having excellent heat dissipation and maintaining the fluidity (excellent moldability).

In particular, the particulate boron nitride preferably has a D50 of 30 μm or smaller and a kurtosis of 0 or lower, more preferably a D50 of 20 μm or smaller and a kurtosis of −0.1 or lower.

Herein, the particle size distributions of the particulate boron nitride in the resin composition may be those determined for particulate boron nitride residues obtained by incinerating the resin composition.

To achieve both heat dissipation and moldability at a much higher level, the resin composition of the disclosure preferably contains the particulate boron nitride in an amount of 30 to 65% by volume. The amount is preferably 35% by volume or more, more preferably 38% by volume or more, still more preferably 40% by volume or more. The amount is preferably 60% by volume or less. The amount may be 55% by volume or less and may be 50% by volume or less. The resin composition of the disclosure has excellent moldability although it contains a relatively large amount of particulate boron nitride as described above.

The resin composition of the disclosure may contain different components in addition to the fluororesin, the fluorine-free resin, and the particulate boron nitride. Examples of the different components include reinforcing fibers, fillers, plasticizers, processing aids, mold lubricants, pigments, flame retarders, lubricants, light stabilizers, weathering agents, conducting agents, antistatic agents, ultraviolet absorbers, antioxidants, foaming agents, perfumes, oils, softeners, dehydrofluorinating agents, and nucleating agents. Examples of the reinforcing fibers include carbon fibers, glass fibers, and basalt fibers. Examples of the fillers include polytetrafluoroethylene, mica, silica, talc, cerite, clay, titanium oxide, and barium sulfate. An example of the conducting agents is carbon black. Examples of the plasticizers include dioctyl phthalic acid and pentaerythritol. Examples of the processing aids include carnauba wax, sulfone compounds, low molecular weight polyethylene, and fluorine-based aids. Examples of the dehydrofluorinating agents include organic oniums and amidines.

The resin composition of the disclosure preferably has a thermal conductivity of 1.0 W/m·K or higher, more preferably 1.3 W/m·K or higher, still more preferably 1.5 W/m·K or higher, further preferably 2.0 W/m·K or higher, particularly preferably 2.3 W/m·K or higher. A thermal conductivity within the above range allows the resin composition to have better heat dissipation.

The thermal conductivity can be calculated as the product of the thermal diffusivity, the specific heat capacity, and the density measured by the following methods.

### (Thermal Diffusivity)

Device: ai-Phase Mobile 1 available from ai-Phase Co., Ltd.

Measurement temperature: 25° C.
Sample: a 0.5-mmt plate obtained by press-molding
Measurement is performed with N=3 and the average thereof is used.

### Conditions for Press-Molding a Sample

Device: heat press IMC-11FA available from Imoto Machinery Co., Ltd.
Molding temperature: 360° C.
Pressure: 10 MPa
Press duration: 2 min

### (Specific Heat Capacity)

The specific heat capacity is measured in conformity with JIS K 7123, and the value at 25° C. is used.

### (Density)

The measurement is performed in conformity with JIS Z 8807.

The resin composition preferably has a melt flow rate (MFR) of 1 g/10 min or higher. A MFR within the above range allows the resin composition to have excellent moldability. In particular, the resin composition is allowed to have moldability that enables injection molding. The MFR of the resin composition of the disclosure is preferably 2 g/10 min or higher, more preferably 3 g/10 min or higher, while preferably 100 g/10 min or lower, more preferably 70 g/10 min or lower, still more preferably 50 g/10 min or lower. The MFR of the resin composition of the disclosure is a value determined using a die having a diameter of 2.095 mm and a length of 8 mm at a load of 5 kg and 372° C. in conformity with ASTM D-1238.

The resin composition of the disclosure preferably has a relative permittivity of 3.6 or lower. The resin composition having a relative permittivity within the above range can be suitably used in applications that require low dielectric properties. The relative permittivity of the resin composition of the disclosure is more preferably 3.5 or lower, still more preferably 3.4 or lower, particularly preferably 3.3 or lower. The lower limit of the relative permittivity is not limited, but is preferably 2.5 or higher, more preferably 2.6 or higher, still more preferably 2.7 or higher. The relative permittivity of the resin composition of the disclosure is measured in conformity with ASTM D 150 at 6 GHz and 25° C. using a cavity resonator permittivity measurement device (available from Agilent Technologies, Inc.).

The resin composition of the disclosure is preferably one capable of providing a specimen in conformity with ASTM D790 by injection molding at a cylinder temperature of 370° C. and a mold temperature of 180° C. using a 15-t injection molding machine. Such a resin composition can have further excellent injection moldability. The 15-t injection molding machine may be, for example, M26/15B available from Sumitomo Heavy Industries, Ltd.

The resin composition of the disclosure may have any form, such as powder, granules, or pellets. The resin composition preferably in the form of pellets because pellets are easy to use in injection molding.

The resin composition of the disclosure may be produced by, for example, mixing the fluororesin, the fluorine-free resin, and the particulate boron nitride, as well as a different component, if necessary. The mixing may be performed using a single-screw or twin-screw extruder.

In order to achieve both heat dissipation and moldability at a much higher level, the resin composition of the disclosure is preferably obtainable by melt-kneading.

In the case of producing the resin composition of the disclosure by melt-kneading, the particulate boron nitride material used is preferably in the form of agglomerated particles of boron nitride. Melt-kneading this particulate boron nitride material with the fluororesin enables easy control of the MFR of the resulting resin composition to fall within the range described later. Such melt-kneading also enables easy control of the particle size distribution of the particulate boron nitride in the resulting resin composition to fall within the above preferred range. The agglomerated particles are agglomerated primary particles of boron nitride.

The particulate boron nitride material preferably has an aspect ratio (major axis/minor axis) of 1.0 to 3.0, more preferably 1.0 to 2.5.

The aspect ratio can be calculated from the major axis and the minor axis measured using a scanning electron microscope (SEM), and the aspect ratio used is an average of the aspect ratios measured for 30 samples.

Specific examples of the particulate boron nitride material include UHP-G1H available from Showa Denko K.K., CF600 available from Momentive, and FS-3 available from Mizushima Ferroalloy Co., Ltd.

The melt-kneading temperature is preferably higher than the melting point of the fluororesin, more preferably a temperature 5° C. or more higher than the melting point of the fluororesin.

The resin composition of the disclosure has excellent heat dissipation as well as excellent moldability and thus can be molded into various shapes for use in the fields requiring heat dissipation, such as the electrical and electronic device field, the automobile field, and the LED field. For example, the resin composition is suitable for electrical/electronic device parts such as connectors, sockets, relay parts, coil bobbins, optical pickups, radiators, printed circuit boards, and computer-related parts. Since the resin composition of the disclosure has excellent heat dissipation and low relative permittivity while also having excellent moldability, the resin composition is particularly suitable for printed circuit boards. The resin composition is also applicable to electric wire coating materials, motor parts, motor insulators, LED lamp sockets, and parts for lithium-ion batteries.

The resin composition of the disclosure can be molded into a molded article. A molded article containing the resin composition is also one aspect of the disclosure. The method for molding the resin composition is not limited. The resin composition is preferably molded by any of injection molding, extrusion molding, compression molding, cutting, and wire coating extrusion. A method of producing a molded article by the molding method is also one aspect of the disclosure.

The resin composition of the disclosure has excellent fluidity and thus can be favorably molded by injection molding. A molded article obtained by injection molding the resin composition of the disclosure is a favorable aspect of the disclosure.

The molded article may have any shape such as a sheet, a film, a rod, or a pipe.

The disclosure relates to a resin composition containing: a melt-fabricable fluororesin containing at least one functional group selected from the group consisting of a carbonyl group-containing group and a hydroxy group; at least one fluorine-free resin selected from the group consisting of a liquid crystal polymer, a polyarylene sulfide, and an aromatic polyether ketone; and particulate boron nitride.

Preferably, in the resin composition of the disclosure, the particulate boron nitride is contained in an amount of 30 to 65% by volume.

Preferably, in the resin composition of the disclosure, the fluororesin is contained in an amount of 10 to 50% by volume.

Preferably, in the resin composition of the disclosure, the fluorine-free resin is contained in an amount of 10 to 50% by volume.

Preferably, the particulate boron nitride has a kurtosis of 0 or lower.

Preferably, the fluororesin has a melting point of 100° C. or higher and 325° C. or lower.

Preferably, the fluororesin includes at least one selected from the group consisting of a tetrafluoroethylene/perfluoro(alkyl vinyl ether) copolymer and a tetrafluoroethylene/hexafluoropropylene copolymer.

Preferably, the resin composition of the disclosure has a thermal conductivity of 1.0 W/m·K or higher.

Preferably, the resin composition of the disclosure has a relative permittivity of 3.6 or lower.

The disclosure also provides a molded article containing the resin composition.

The disclosure also provides a method for producing a molded article, the method including molding the resin composition by any of injection molding, extrusion molding, compression molding, cutting, and wire coating extrusion.

### EXAMPLES

The disclosure is specifically described with reference to examples, but the examples are not intended to limit the disclosure.

The physical properties in the examples and the comparative examples were measured by the following methods.

### MFR of Resin Composition

The MFR was measured using a melt indexer with a die having a diameter of 2.095 mm and a length of 8 mm in conformity with ASTM D-1238 at 372° C. and a load of 5 kg.

### Thermal Conductivity

The thermal conductivity was calculated as a product of the thermal diffusivity, the specific heat capacity, and the density measured by the following methods.

### (Thermal Diffusivity)

Device: ai-Phase Mobile 1 available from ai-Phase Co., Ltd.

Measurement temperature: 25° C.
Sample: a 0.5-mmt plate obtained by press-molding
Measurement was performed with N=3 and the average thereof was used.

### Conditions for Press-Molding a Sample

Device: heat press IMC-11FA available from Imoto Machinery Co., Ltd.
Molding temperature: 360° C.
Pressure: 10 MPa
Press duration: 2 min

### (Specific Heat Capacity)

The specific heat capacity was measured in conformity with JIS K 7123, and the value at 25° C. was used.

### (Density)

The density was measured in conformity with JIS Z 8807.

### Injection Moldability

The moldability was determined by whether the resin composition was capable of being molded into a specimen in conformity with ASTM D790. Injection molding was performed using a 15-t injection molding machine M26/15B available from Sumitomo Heavy Industries, Ltd., at a cylinder temperature of 370° C. and a mold temperature of 180° C.

The cases where the resin was molded into a specimen were evaluated as good. The cases where the resin was not molded into a specimen were evaluated as poor.

### Particle Size Distribution of Particulate Boron Nitride in Resin Composition and Kurtosis

A nickel crucible was charged with 5 g of pellets of the resin composition. The contents were superheated at 600° C. for two hours in an electric muffle furnace (FUW222PA, available from Advantech Toyo Kaisha, Ltd.), so that the resin was incinerated. Thereby, an incineration residue was obtained.

The resulting residue was subjected to measurement with a laser diffraction particle size distribution analyzer (laser diffraction particle size distribution analyzer Mastersizer 3000+Hydro R, available from Malvern Panalytical Ltd.) under the following conditions. The evaluation was on a volume basis. The measurement was performed with N=20. After it was confirmed that the particle size distribution was stabilized, the last data was used. The kurtosis was calculated based on the last data of the 20 measurements.

### (Measurement Conditions)

Solvent: ethanol
Solvent amount: 45 ml
Stirring conditions: 3000 rpm
Laser scattering intensity: 10 to 20% (solution concentration 0.01 to 0.02%)

### Relative Permittivity

The relative permittivity was measured in conformity with ASTM D 150 at 6 GHz and 25° C. using a cavity resonator permittivity measurement device (Network analyzer system available from Agilent Technologies, Inc.).

### <Measurement Method for Melt Viscosity>

The melt viscosity of the polyether ketone resin was measured in conformity with ASTM D3835 under the conditions of 60 sec⁻¹ and 390° C.

The materials used in examples and comparative examples are as follows.

### (Fluororesin)

PFA: tetrafluoroethylene/perfluoro(alkyl vinyl ether) copolymer, MFR=70 g/10 min, 230 carbonyl groups/10⁶ carbon atoms, melting point: 311° C.

### <Number of Carbonyl Group-Containing Functional Groups>

White powder of the fluorine-containing copolymer (b) or a piece cut out of a melt-extruded pellet of the fluorine-containing copolymer (b) was compression-molded at room temperature to form a film having a thickness of 50 to 200 μm. This film was analyzed by infrared absorption spectrometry to measure the absorbance of the peak assigned to a carbonyl group-containing functional group. Then, the number N of carbonyl group-containing functional groups in the polymer forming the fluorine-containing copolymer (b) per 10⁶ main chain carbon atoms was calculated according to the following equation.

N=500 AW/εdf

A: absorbance of a peak assigned to a carbonyl group-containing functional group

ε: mole absorbance coefficient of a peak assigned to a carbonyl group-containing functional group

W: average molecular weight of the monomers calculated from the composition of the fluorine-containing copolymer (b)

d: film density (g/cm³)

f: film thickness (mm)

The analysis by infrared absorption spectrometry was performed with Perkin-Elmer FTIR spectrometer (available from Perkin Elmer Japan Co., Ltd.). The film thickness was measured with a micrometer.

### (Fluorine-Free Resin)

LCP: thermotropic liquid crystal polymer, X7G (type-III liquid crystal polymer, available from Eastman Kodak Company), the amount of paraoxybenzoic acid units copolymerized: 40 mol %, liquid crystal starting temperature: 245° C.
PPS: polyphenylene sulfide, MFR 125 g/10 min
PEEK: polyetheretherketone (MFR 38 g/10 min, melt viscosity; 1.19 kNsm⁻²)

### (Boron Nitride)

BN1: UHP-G1H available from Showa Denko K.K., aggregated boron nitride particles, average particle size 50 μm
BN2: PT110 available from Momentive, flaky boron nitride particles, average particle size 45 μm

### Examples 1 to 11 and Comparative Examples 1 to 6

The materials were kneaded in accordance with the formulations shown in Tables 1 to 3 in a twin extruder at a cylinder temperature of 360° C. to prepare fluororesin-containing compositions. The obtained fluororesin-containing compositions were injection-molded in an injection molding machine set at a cylinder temperature of 370° C. and a mold temperature of 180° C. to mold specimens in conformity with ASTM D790.

TABLE 1

| | | | Example 1 | Example 2 | Example 3 | Example 4 | Example 5 |
|---|---|---|---|---|---|---|---|
| Formulation | PFA | vol % | 50 | 20 | 36 | 10 | 20 |
| | LCP | | 20 | 50 | 24 | 40 | 30 |
| | PPS | | | | | | |
| | PEEK | | | | | | |
| | BN1 | | 30 | 30 | 40 | 50 | 50 |
| | BN2 | | | | | | |
| | Total | | 100 | 100 | 100 | 100 | 100 |
| Evaluation | Thermal conductivity | W/m · K | 1.3 | 1.7 | 2.5 | 3.6 | 3.8 |
| | Relative permittivity | — | 2.5 | 2.7 | 3.0 | 3.5 | 3.4 |
| | Injection moldability | — | Good | Good | Good | Good | Good |
| Particulate | D50 | (μm) | 8.7 | 18.7 | 11.2 | 18.7 | 14.5 |
| boron nitride | Kurtosis | | −0.6 | −0.2 | −0.4 | −0.1 | −1.5 |
| particle size | | | | | | | |
| distribution | | | | | | | |

TABLE 2

| | | | Example 6 | Example 7 | Example 8 | Example 9 | Example 10 | Example 11 |
|---|---|---|---|---|---|---|---|---|
| Formulation | PFA | vol % | 30 | 24 | 30 | 24 | 21 | 30 |
| | LCP | | 20 | 16 | | | | |
| | PPS | | | | 20 | 16 | 14 | |
| | PEEK | | | | | | | 20 |
| | BN1 | | 50 | 60 | 50 | 60 | 65 | 50 |
| | BN2 | | | | | | | |
| | Total | | 100 | 100 | 100 | 100 | 100 | 100 |
| Evaluation | Thermal conductivity | W/m · K | 2.9 | 5.0 | 2.6 | 4.2 | 4.5 | 2.7 |
| | Relative permittivity | — | 3.1 | 3.3 | 3.2 | 3.4 | 3.5 | 3.2 |
| | Injection moldability | — | Good | Good | Good | Good | Good | Good |
| Particulate | D50 | (μm) | 8.7 | 8.7 | 11.2 | 8.7 | 7.6 | 9.0 |
| boron nitride | Kurtosis | | 0.0 | −0.5 | −0.8 | −0.8 | −0.6 | −0.4 |
| particle size | | | | | | | | |
| distribution | | | | | | | | |

TABLE 3

| | | | Comparative | Comparative | Comparative | Comparative | Comparative | Comparative |
|---|---|---|---|---|---|---|---|---|
| | | | Example 1 | Example 2 | Example 3 | Example 4 | Example 5 | Example 6 |
| Formulation | PFA | vol % | 60 | | 40 | 50 | 50 | |
| | LCP | | 40 | 50 | | | | |
| | PPS | | | | | | | 50 |
| | BN1 | | | 50 | 60 | 50 | | 50 |
| | BN2 | | | | | | 50 | |
| | Total | | 100 | 100 | 100 | 100 | 100 | 100 |
| Evaluation | Thermal conductivity | W/m · K | 0.3 | 3.4 | 2.5 | 1.9 | 2.0 | 2.6 |
| | Relative permittivity | — | 2.8 | 3.7 | 2.7 | 2.6 | 2.6 | 3.9 |
| | Injection moldability | — | Good | Good | Poor | Poor | Poor | Good |
| Particulate | D50 | (μm) | — | 27.4 | 4.6 | 4.6 | 21.2 | 7.6 |
| boron nitride | Kurtosis | | — | −0.1 | 1.9 | 1.8 | 0.7 | −0.6 |
| particle size | | | | | | | | |
| distribution | | | | | | | | |

The resin compositions of Examples 1 to 11 had excellent thermal conductivity (heat dissipation) and moldability, and also had a relative permittivity as low as 3.5 or lower. In contrast, the resin composition of Comparative Example 1, containing no particulate boron nitride, had low thermal conductivity (heat dissipation). The resin compositions of Comparative Examples 2 and 6, containing no fluororesin, had high relative permittivity. The resin compositions of Comparative Examples 3 to 5, containing no fluorine-free resin such as LCP, had poor injection moldability.

What is claimed is:

1. A resin composition comprising:
a melt-fabricable fluororesin containing at least one functional group selected from the group consisting of a carbonyl group-containing group and a hydroxy group;
at least one fluorine-free resin selected from the group consisting of a liquid crystal polymer, a polyarylene sulfide, and an aromatic polyether ketone; and
particulate boron nitride,
wherein the particulate boron nitride is contained in an amount of 30 to 65% by volume.

2. The resin composition according to claim 1,
wherein the fluororesin is contained in an amount of 10 to 50% by volume.

3. The resin composition according to claim 1,
wherein the fluorine-free resin is contained in an amount of 10 to 50% by volume.

4. The resin composition according to claim 1,
wherein the particulate boron nitride has a kurtosis of 0 or lower.

5. The resin composition according to claim 1,
wherein the fluororesin has a melting point of 100° C. or higher and 325° C. or lower.

6. The resin composition according to claim 1,
wherein the fluororesin includes at least one selected from the group consisting of a tetrafluoroethylene/perfluoro(alkyl vinyl ether) copolymer and a tetrafluoroethylene/hexafluoropropylene copolymer.

7. The resin composition according to claim 1,
wherein the resin composition has a thermal conductivity of 1.0 W/m·K or higher.

8. The resin composition according to claim 1,
wherein the resin composition has a relative permittivity of 3.6 or lower.

9. A molded article comprising the resin composition according to claim 1.

10. A method for producing a molded article, the method comprising
molding the resin composition according to claim 1 by any of injection molding, extrusion molding, compression molding, cutting, and wire coating extrusion.
